(19) United States
(12) Patent Application Publication
(10) Pub. No.: US 2026/0257546 A1
(43) Pub. Date: Sep. 3, 2026

(54) PROTECTIVE VEHICLE COVER DEVICE

(71) Applicant: Jason Christopher, Georgetown, KY (US)

(72) Inventor: Jason Christopher, Georgetown, KY (US)

(21) Appl. No.: 19/555,187

(22) Filed: Mar. 3, 2026

Related U.S. Application Data
(60) Provisional application No. 63/766,011, filed on Mar. 3, 2025.

(51) Int. Cl. B60J 11/00; B32B 3/20; B32B 5/02; B32B 27/06

(52) U.S. Cl. CPC B60J 11/00; B32B 3/20; B32B 5/02; B32B 27/06; B32B 2250/03; B32B 2307/712

(57) ABSTRACT

A protective vehicle cover device is provided. The device is comprised of a vehicle cover device designed for comprehensive vehicle protection during shipping/transport. The device comprises a three-layer body that includes a bottom layer made of vehicle finish-friendly material, a middle layer containing at least one liquid-filled bubble designed to change color upon impact to signal potential vehicle damage, and a weatherproof top layer to protect against environmental elements. The invention features at least one magnet-based fastener for secure attachment to the vehicle's exterior without causing damage, facilitated by the protective materials of the bottom layer and, in certain embodiments, an additional protective covering on the fastener itself.

### CROSS-REFERENCE TO RELATED APPLICATION

The present application claims priority to, and the benefit of, U.S. Provisional Application No. 63/766,011, which was filed on March 3, 2025, and is incorporated herein by reference in its entirety.

### FIELD OF THE INVENTION

The present invention relates generally to the field of vehicle covers. More specifically, the present invention relates to a protective vehicle cover device that provides an easily attachable vehicle cover that indicates impact damage via color changing. Accordingly, the present disclosure makes specific reference thereto. Nonetheless, it is to be appreciated that aspects of the present invention are also equally applicable to other like applications, devices, and methods of manufacture.

### BACKGROUND

Vehicle covers play an indispensable role in safeguarding vehicles during transport, acting as a barrier against a wide range of potential damages. These protective layers are especially critical during transit, a period when vehicles find themselves exceptionally vulnerable to external threats. Exposed to the harsh realities of the environment, including inclement weather conditions and a plethora of roadway debris, vehicles are at a heightened risk of sustaining various forms of damage. Such exposure can mar the vehicle's surface with scratches, dents, and other imperfections, significantly detracting from its aesthetic appeal and, by extension, its overall market value.

Nevertheless, while existing vehicle covers are instrumental in offering physical protection they cannot signal to users when vehicle damage has occurred beneath the cover. This deficiency means that, despite the physical barrier, vehicles can still incur damage that remains unnoticed until the cover is removed, potentially delaying necessary repairs and complicating insurance claims. Furthermore, the practical challenges associated with attaching these covers to vehicles add another layer of complexity. Often large and unwieldy, the covers can be difficult to maneuver and secure in place, requiring considerable effort and time from the user. This cumbersome nature not only makes the process of applying the covers a daunting task but also raises questions about their convenience and user-friendliness.

Therefore, there exists a long-felt need in the art for an improved vehicle cover. There also exists a long-felt need in the art for a protective vehicle cover device. More specifically, there exists a long-felt need in the art for a protective vehicle cover device that can be easily secured to a vehicle to protect the vehicle from damage during transport. Further, there exists a long-felt need in the art for a protective vehicle cover device that can be easily secured to a vehicle to protect the vehicle from damage during transport and wherein the device has a means of notifying a user if the vehicle has been damaged underneath the device.

The subject matter disclosed and claimed herein, in one embodiment thereof, comprises a protective vehicle cover device. The device is comprised of a vehicle cover device designed for comprehensive vehicle protection during shipping/transport. The device comprises a three-layer body that includes a bottom layer made of vehicle finish-friendly material, a middle layer containing at least one liquid-filled bubble designed to change color upon impact to signal potential vehicle damage and a weatherproof top layer to protect against environmental elements. The invention features at least one magnet-based fastener for secure attachment to the vehicle's exterior without causing damage, facilitated by the protective materials of the bottom layer and, in certain embodiments, an additional protective covering on the fastener itself.

In this manner, the protective vehicle cover device of the present invention accomplishes all the foregoing objectives and provides an improved vehicle cover. More specifically, the device can be easily secured to a vehicle to protect the vehicle from damage during transport via at least one fastener. Further, the liquid layer ensures the device has a method of notifying a user if the vehicle has been damaged underneath the device.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a protective vehicle cover device comprised of a vehicle cover with a body preferably comprised of a bottom layer, a middle layer, and a top layer. The body may be any size, shape, and configuration that may cover any portion/area of a vehicle (and/or the entire vehicle).

The bottom layer of the body contacts the exterior surface of a vehicle during use and is made from a material that does not damage the exterior finish of the vehicle. The middle layer of the body is comprised of at least one bubble filled with at least one liquid that is preferably a washable, colored liquid of any color. As a result, if debris impacts the body during transport and punctures the bubble, the liquid will be released such that the impact area of the body changes color. In this manner, a user can examine the area of the vehicle underneath said area for damage. The top layer is comprised of weatherproof material that protects the vehicle exterior from weather during transport.

The body is also comprised of at least one fastener, preferably comprised of a magnet of any type. In one embodiment, the fastener is positioned between the middle layer and bottom layer such that the fastener allows magnetic attachment to a vehicle exterior and wherein the bottom layer protects the vehicle exterior from being damaged by the fastener. In another embodiment, the fastener is positioned on a bottom surface of the bottom layer.

The present invention is also comprised of a method of using the device. First, a device is provided comprised of a body comprised of at least one fastener, a bottom layer, a middle layer comprised of at least one bubble, and a top layer. Then, the device can be attached to an exterior of a vehicle via the fastener prior to transporting/shipping the vehicle. Upon arrival at the shipping destination, a user can inspect the body for color change caused by the release of a liquid from the bubble that indicates the vehicle may have been damaged by a debris impact.

Accordingly, the protective vehicle cover device of the present invention is particularly advantageous as it provides an improved vehicle cover. More specifically, the device can be easily secured to a vehicle to protect the vehicle from damage during transport via at least one fastener. Further, the liquid layer ensures the device has a method of notifying a user if the vehicle has been damaged underneath the device. In this manner, the protective vehicle cover device overcomes the limitations of existing vehicle covers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a cross-sectional side view of one potential embodiment of a protective vehicle cover device of the present invention in accordance with the disclosed architecture;

FIG. 2 illustrates a cross-sectional side view of one potential embodiment of a protective vehicle cover device of the present invention in accordance with the disclosed architecture;

FIG. 3 illustrates a side view of one potential embodiment of a protective vehicle cover device of the present invention in accordance with the disclosed architecture; and

FIG. 4 illustrates a flowchart of a method of using one potential embodiment of a protective vehicle cover device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved vehicle cover. There also exists a long-felt need in the art for a protective vehicle cover device. More specifically, there exists a long-felt need in the art for a protective vehicle cover device that can be easily secured to a vehicle to protect the vehicle from damage during transport. Further, there exists a long-felt need in the art for a protective vehicle cover device that can be easily secured to a vehicle to protect the vehicle from damage during transport and wherein the device has a means of notifying a user if the vehicle has been damaged underneath the device.

The present invention, in one exemplary embodiment, is comprised of a protective vehicle cover device. The device is comprised of a vehicle cover with a body preferably comprised of a bottom layer, a middle layer, and a top layer wherein the body may be any size, shape, and configuration that may cover any portion/area of a vehicle (and/or the entire vehicle).

The bottom layer of the body contacts the exterior surface of a vehicle during use and is made from a material that does not damage the exterior finish of the vehicle. The middle layer of the body is comprised of at least one bubble filled with at least one liquid that is preferably a washable, colored liquid of any color. As a result, if debris impacts the body during transport and punctures the bubble, the liquid will be released such that the impact area of the body changes color. Therefore, a user can examine the area of the vehicle underneath said area for damage. The top layer is comprised of weatherproof material that protects the vehicle exterior from weather during transport.

The body is also comprised of at least one fastener. The fastener is preferably comprised of a magnet of any type positioned between the middle layer and bottom layer such that the fastener allows magnetic attachment to a vehicle exterior and wherein the bottom layer protects the vehicle exterior from being damaged by the fastener. In another embodiment, the fastener is positioned on a bottom surface of the bottom layer.

The present invention is also comprised of a method of using the device. First, a device is provided comprised of a body comprised of at least one fastener, a bottom layer, a middle layer comprised of at least one bubble, and a top layer. Then, the device can be attached to an exterior of a vehicle via the fastener prior to transporting/shipping the vehicle. Upon arrival at the shipping destination, a user can inspect the body for color change caused by the release of a liquid from the bubble that indicates the vehicle may have been damaged by a debris impact.

Accordingly, the protective vehicle cover device of the present invention is particularly advantageous as it provides an improved vehicle cover. More specifically, the device can be easily secured to a vehicle to protect the vehicle from damage during transport via at least one fastener. Further, the liquid layer ensures the device has a method of notifying a user if the vehicle has been damaged underneath the device. In this manner, the protective vehicle cover device overcomes the limitations of existing vehicle covers known in the art.

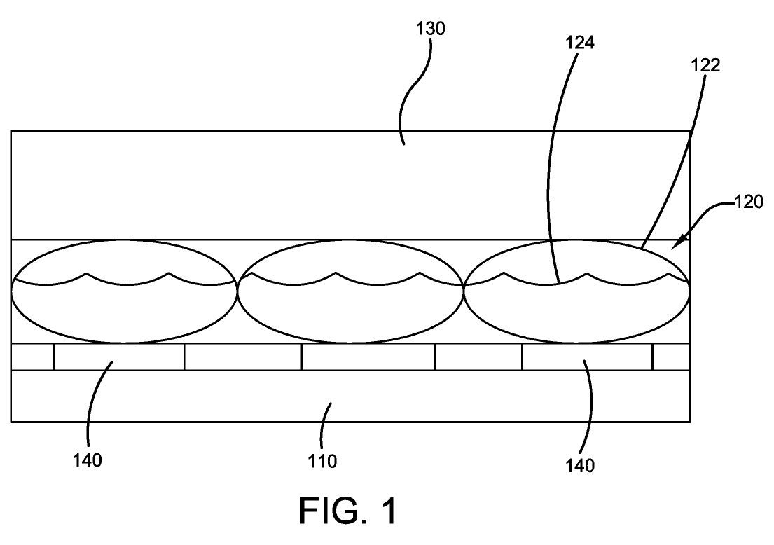

Referring initially to the drawings, FIG. 1 illustrates a cross-sectional side view of one potential embodiment of a protective vehicle cover device 100 of the present invention in accordance with the disclosed architecture. The device 100 is comprised of a vehicle cover with a body 102 comprised of at least one layer 110, 120, 130, but is preferably comprised of a bottom layer 110, a middle layer 120, and a top layer 130. The body 102 may be any size, shape, and configuration that may cover any portion/area of a vehicle (and/or the entire vehicle).

The bottom layer 110 of the body 102 contacts the exterior surface of a vehicle during use. As a result, the bottom layer 110 is made from a material that does not damage the exterior finish of the vehicle. Said material includes, but is not limited to, microfiber, non-woven fabric, cotton, lycra, spandex, flannel, felt, etc.

The middle layer 120 of the body 110 is comprised of at least one bubble 122. The bubble 122 may be any size, shape, and configuration and may be positioned anywhere in any arrangement within the middle layer. The bubble 122 is filled with at least one liquid 124. The liquid 124 is preferably a washable, colored liquid of any color. As a result, if debris impacts the body 102 during transport and punctures the bubble 122, liquid 124 will be released such that the impact area of the body 102 changes color. In this manner, a user can examine the area of the vehicle underneath said area for damage.

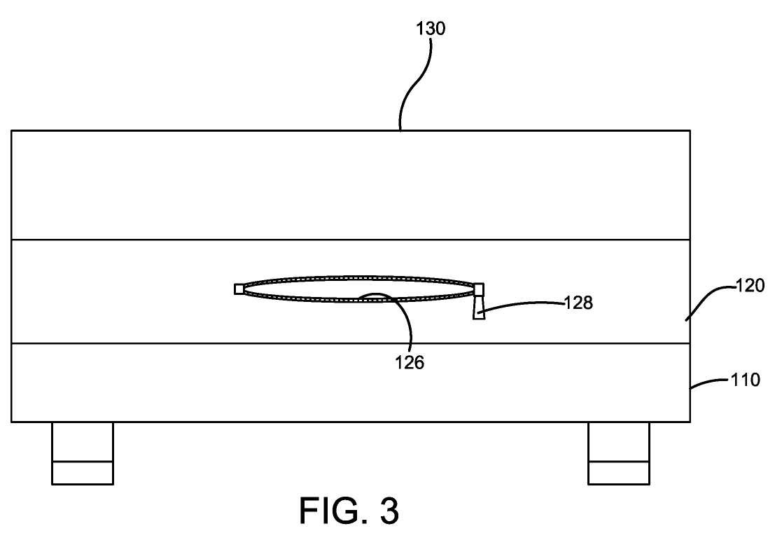

In one embodiment, the middle layer 120 is comprised of an opening 126, as seen in FIG. 3. The opening 126 allows the bubble 122 to be inserted into the middle layer 120 and then removed when damaged. The opening 126 may be comprised of at least one fastener 128 such as, but not limited to, a zipper.

The top layer 130 is comprised of weatherproof material. This material protects the vehicle exterior from weather during transport. Said material may include, but is not limited to, polyethylene, polypropylene, olefin, vinyl, acrylic, etc.

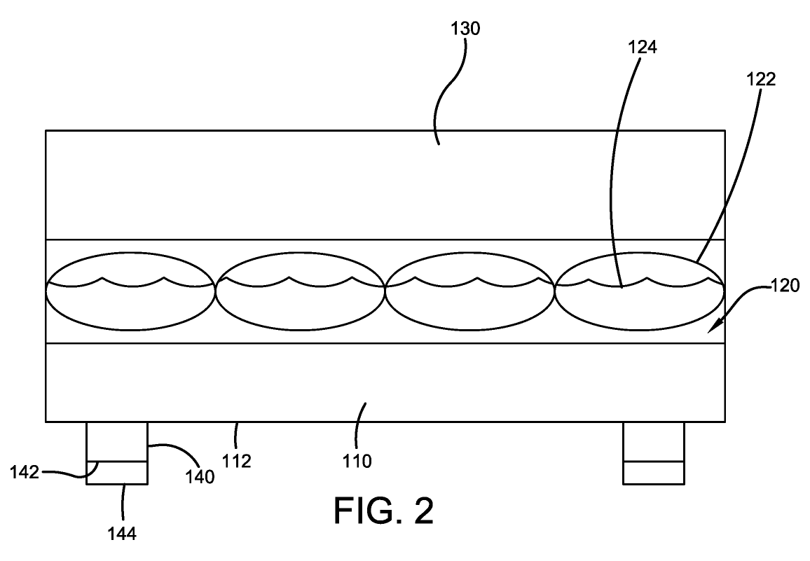

The body 102 is also comprised of at least one fastener 140. The fastener 140 is preferably comprised of a magnet of any type. The fastener 140 may be positioned throughout the body 102 in different embodiments. In one embodiment, the fastener 140 is positioned between the middle layer 120 and bottom layer 110 (as seen in FIG. 2.) such that the fastener 140 allows magnetic attachment to a vehicle exterior and wherein the bottom layer 110 protects the vehicle exterior from being damaged by the fastener 140. In another embodiment, the fastener 140 is positioned on a bottom surface 112 of the bottom layer 110, as seen in FIG. 1. In this embodiment, the bottom surface 142 of the fastener 140 may be comprised of a protective covering 144. The covering 144 is preferably made from the same material as the bottom layer 110 to ensure the fastener 140 does not damage the exterior of a vehicle.

All layers 110, 120, 130 of the body 102 are preferably washable to allow the body 102 to be reused as needed.

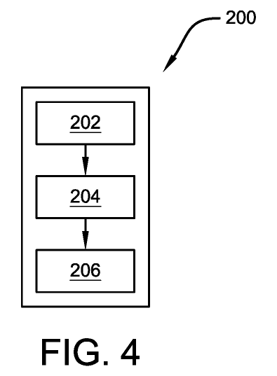

The present invention is also comprised of a method of using 200 the device 100, as seen in FIG. 4. First, a device 100 is provided comprised of body 102 comprised of at least one fastener 140, a bottom layer 110, a middle layer 120 comprised of at least one bubble 122 filled with a colored liquid, and a top layer 130 [Step 202]. Then, the device 100 can be attached to an exterior of a vehicle via the fastener 140 prior to transporting/shipping the vehicle [Step 204]. Upon arrival at the shipping destination, a user can inspect the body 102 for color change caused by the release of a liquid 124 from the bubble 122 that indicates the vehicle may have been damaged by a debris impact and then may inspect the vehicle for damage [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “protective vehicle cover device” and “device” are interchangeable and refer to the protective vehicle cover device 100 of the present invention.

Notwithstanding the foregoing, the protective vehicle cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the protective vehicle cover device 100 as shown in the FIGS. are for illustrative purposes only, and that many other sizes and shapes of the protective vehicle cover device 100 are well within the scope of the present disclosure. Although the dimensions of the protective vehicle cover device 100 are important design parameters for user convenience, the protective vehicle cover device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective vehicle cover device comprising:
a top layer;
a middle layer comprised of a bubble filled with a liquid;
a bottom layer; and
a fastener positioned between the bottom layer and the middle layer.

2. The protective vehicle cover device of claim 1, wherein the fastener is comprised of a magnet.

3. The protective vehicle cover device of claim 1, wherein the bottom layer is comprised of a microfiber, a non-woven fabric, a cotton, a lycra, a spandex, a flannel, or a felt.

4. The protective vehicle cover device of claim 1, wherein the liquid is comprised of a colored liquid.

5. The protective vehicle cover device of claim 4, wherein the liquid is comprised of a washable liquid.

6. The protective vehicle cover device of claim 1, wherein the middle layer is comprised of an opening.

7. The protective vehicle cover device of claim 6, wherein the bubble is removable from the middle layer.

8. The protective vehicle cover device of claim 6, wherein the opening is comprised of a fastener.

9. The protective vehicle cover device of claim 8, wherein the fastener is comprised of a zipper.

10. A protective vehicle cover device comprising:
a top layer;
a middle layer comprised of a bubble filled with a liquid; and
a bottom layer comprised of a fastener positioned on a bottom surface of the bottom layer.

11. The protective vehicle cover device of claim 10, wherein the fastener is comprised of a magnet.

12. The protective vehicle cover device of claim 10, wherein the bottom layer is comprised of a microfiber, a non-woven fabric, a cotton, a lycra, a spandex, a flannel, or a felt.

13. The protective vehicle cover device of claim 10, wherein the liquid is comprised of a colored liquid.

14. The protective vehicle cover device of claim 13, wherein the liquid is comprised of a washable liquid.

15. The protective vehicle cover device of claim 10, wherein the middle layer is comprised of an opening.

16. The protective vehicle cover device of claim 15, wherein the bubble is removable from the middle layer.

17. The protective vehicle cover device of claim 15, wherein the opening is comprised of a fastener.

18. The protective vehicle cover device of claim 17, wherein the fastener is comprised of a zipper.

19. The protective vehicle cover device of claim 10, wherein the top layer is comprised of a polyethylene, a polypropylene, an olefin, a vinyl, or an acrylic.

20. A method of using a protective vehicle cover device, the method comprising the following steps:
providing a protective vehicle cover device comprised of a fastener, a bottom layer, a middle layer comprised of a bubble filled with a colored liquid, and a top layer;
attaching the protective vehicle cover device to an exterior of a vehicle via the fastener prior to shipping the vehicle; and
inspecting the protective vehicle cover device for a color change upon arrival of the vehicle at a destination and then inspecting the vehicle for damage.
